(19) United States
(12) Patent Application Publication
(10) Pub. No.: US 2015/0203389 A1
(43) Pub. Date: Jul. 23, 2015

(54) METHOD AND INSTALLATION FOR WASTEWATER PROCESS MONITORING AND CONTROL

(71) Applicant: Bactest Limited, Cambridge (GB)

(72) Inventors: Derek Price, Cambridge (GB); Annie Brooking, Cambridge (GB)

(73) Assignee: Bactest Limited, Cambridge (GB)

(21) Appl. No.: 14/421,745

(22) PCT Filed: Aug. 8, 2013
(86) PCT No.: PCT/GB2013/052133

§ 371 Date: Feb. 13, 2015

(30) Foreign Application Priority Data
Aug. 15, 2012 (GB) 1214563.7
Aug. 15, 2012 (GB) 1214564.5

(51) Int. Cl. C02F 3/00; G01L 9/00; C02F 3/12

(52) U.S. Cl. CPC C02F 3/006; C02F 3/12; G01L 9/00; C02F 2209/03

(57) ABSTRACT

We describe a method of closed-loop control of a waste water treatment plant, the method comprising: obtaining a fluid sample from a fluid of said plant; providing said fluid sample to a sealed chamber such that said fluid sample incompletely fills said sealed chamber leaving a headspace; incubating said fluid sample in said sealed chamber; determining a change in pressure in said headspace during said incubating; and controlling a degree of aeration of said waste water treatment plant responsive to said change in pressure. We also describe a method of measuring one or both of the food content and the biomass content of a fluid of a waste water treatment plant, the method comprising determining a value for one or both of food content and biomass content from a change in pres sure.

### FIELD OF THE INVENTION

This invention relates to methods and systems for monitoring and controlling waste water treatment plants, in particular sewage plants. This invention also relates to methods and systems for monitoring fluids in waste water treatment plants, in particular influent and activated sludge in sewage plants.

### BACKGROUND TO THE INVENTION

Waste water treatment accounts for a surprisingly large proportion of the total UK energy supply, by some estimates up to 0.5%. The majority of this energy goes to aeration of the biological floc in a treatment plant, but this process is relatively poorly understood and often not well controlled. In the main sight and smell are used by experienced managers to control a waste water treatment plant (when operating properly, the smell is not unpleasant), supplemented by occasional tests in the UK typically the BOD5 (biological oxygen demand 5 day test) which as the name implies, incubates a field sample over five days to characterise the sample by its oxygen use. Sometimes probes such as a nitrogen, oxygen or ammonia probe are also employed although in practice these do not work well and often fail.

There is therefore a need for improved techniques for managing waste water treatment plants, preferably techniques which allow improved management of shock loads and diurnal/seasonal rhythms.

There is also a need for improved techniques for monitoring fluids in waste water treatment plants

### SUMMARY OF THE INVENTION

Plant Control

According to a first aspect of the invention there is therefore provided a method of closed-loop control of a waste water treatment plant, the method comprising: obtaining a fluid sample from a fluid of said plant; providing said fluid sample to a sealed chamber such that said fluid sample incompletely fills said sealed chamber leaving a headspace; incubating said fluid sample in said sealed chamber; determining a change in pressure in said headspace during said incubating; and controlling a degree of aeration of said waste water treatment plant responsive to said change in pressure.

The inventors have determined that, surprisingly, the change, more particularly drop in pressure in the headspace of a sealed chamber may be employed to monitor one or both of influent and RAS (returned activated sludge) in a waste water treatment plant. The change in pressure is believed to result from combination of use of some gasses, in particular oxygen, in growing bacteria and production of other gasses such as carbon dioxide, during respiration/bacterial growth. Experimentally an initial pressure drop is observed over a period up to one to a few hours followed by a flattening of the curve and subsequent rise in pressure. The initial drop in pressure has been observed experimentally to correlate with the food available to the bacteria in the influent, and with the biomass in the RAS. It has further been established that one or both of these measurements may be employed in closed-loop control of a waste water treatment plant, with a corresponding loop time, typically of less than 8, 4, 2 or 1 hours.

Controlling the aeration in this manner enables the method (in the corresponding system) to determine a sufficient level of aeration without wasting energy in excess aeration, at the same time ensuring that the clear output from the waste water treatment plant has sufficiently low BOD for this to be safely discharged into a water course. The control may be responsive to, for example, one or more of a pressure drop, a rate of pressure drop, and an integrated pressure drop (area under a pressure-time curve).

In some particularly preferred implementations two fluid samples are obtained, one for use in determining a parameter representing a level of food in the influent, another for determining a quantity of living biological material (biomass) in the plant. The former sample may be obtained, for example, from the influent to the plant; the latter from the RAS (returned activate sludge) corresponding parameters may be obtained from respective changes in headspace pressure when incubating these two fluid samples and, without wishing to be bound by theory, it is believed that these parameters represent, respectively levels of food and biomass in the plant. The degree of aeration may then be controlled responsive to a combination of these parameters, for example a ratio of food to biomass (although in principle some other combination may be employed, for example subtracting one parameter from the other).

The particular degree of aeration/control may be determined on a plant-by-plant basis:

typically plants have their own individual characteristics and needs and the control over the aeration equipment may be adapted accordingly. In principle a plant may be categorised into one of a plurality of different sizes/profiles of plant and a starting point for a control procedure determined accordingly.

In some preferred implementations of the method the fluid sample may be aerated (gassed) prior to incubation to aim to improve the uniformity of the initial conditions. Similarly temperature control is preferably applied for example either to ensure that all samples are incubated at substantially the same temperature, or to incubate a sample at substantially the operating temperature of the plant.

In practice it has been found that there is significant noise/variation in the pressure data during an initial period of 5-30 minutes which can give rise to false/confusing data. Thus in some preferred implementations data is disregarded during this initial period of incubation. Likewise changes in available food/gas during the incubation can affect the pressure drop/drop rate after a period of time of one to a few hours. Therefore in some preferred implementations data obtained during an initial period of incubation, and data after 1, 2, 4 or 8 hours, are disregarded.

Experimental work by the inventors indicated the difficulty in obtaining reliable results. In situ it was observed that frequently lorry loads of various different types of waste fluid would be delivered to a plant and it was hypothesised that this could result in substantial changes to the growing conditions for the bacteria and potential toxicity of the fluid. Experimentally dilution, preferably substantial dilution of the fluid sample helped to produce reliable results, it is surmised by effectively diluting out the toxicity. Thus in some preferred embodiments the method includes diluting the fluid sample by at least 90%, 95%, 98%, 99% or more dilution (10% or less original sample remaining) prior to incubating the sample.

Experimental work has indicated that there is a relatively reliable correlation between rate of pressure drop, for example pressure drop per hour, and influent food. Thus embodiments of the method may comprise controlling the degree of aeration responsive to a determined rate of change (drop) of the pressure in the headspace of the sealed chamber.

Experimentally it has been determined that varying the sample to headspace ratio significantly affects the observed change in pressure and can be used as a mechanism to adjust the sensitivity of the measurement, in effect the loop gain of the control loop. Again this is a parameter which may be varied from plant to plant. In a similar way the degree of dilution may also be adjusted to provide control of sensitivity/loop gain.

In a corresponding aspect the invention provides a control system for closed-loop control of a waste water treatment plant, the system comprising: a culture vessel comprising a sealable chamber for culturing a fluid sample and a pressure measurement transducer for measuring a pressure in a headspace of said sealable chamber; and a data processing system to: input pressure data from said pressure measurement transducer; determine at least one parameter relating to said plant from said pressure data; and output data, for controlling a degree of aeration of said plant, dependent on said at least one parameter; in particular to determine a degree of aeration for said plant from said at least one parameter; and output aeration control data, for controlling a degree of aeration of said plant, dependent on a said determined degree of aeration.

In embodiments the data processing system may be implemented in hardware, or in software, or using a combination of the two. Thus, for example, the data processing system may comprise a microprocessor coupled to working memory and to program memory storing processor control code for a procedure to implement the above described system/method. Optionally in embodiments two culture vessels may be provided, one as a control.

The aeration control data may be output either directly to a control system for the treatment plant or indirectly, for example on a screen or printout to a user for manual adjustment/control of the aeration system. The aeration control data may indicate a degree of aeration or may simply comprise a binary or/less indication.

The skilled person will appreciate that the previously described features of the control method may be implemented in the control system. Thus the embodiments of the control system comprise means for implementing previously described aspects and embodiments of the method.

Plant Monitoring

According to a first aspect of the invention there is therefore provided a method of measuring one or both of the food content and the biomass content of a fluid of a waste water treatment plant, the method comprising: obtaining a fluid sample from a fluid of said plant; providing said fluid sample to a sealed chamber such that said fluid sample incompletely fills said sealed chamber leaving a headspace; incubating said fluid sample in said sealed chamber; determining a change in pressure in said headspace during said incubating; and determining a value for one or both of said food content and said biomass content from said change in pressure.

The inventors have, through experiment, determined that a value for food/biomass content in fluid from a waste water treatment plant may be determined from a change, more particularly a drop, in pressure when the fluid is incubated. This is surprising as the growth/metabolism of bacteria, protozoa and the like both uses gas (oxygen) and produces gas (CO₂). Without wishing to be bound by theory the overall drop in pressure is believed to relate to the overall production of a large number of bacteria in part from the gas in the headspace—without this one might expect that the gas use and production would approximately balance. In some preferred embodiments of the method the fluid sample(s) are aerated to provide a common based line gas level when starting the procedure, to avoid effects which can otherwise be seen due to restriction in bacterial growth due to gas depletion.

In embodiments of the method the fluid sample comprises a sample of influent to the plant (inflow after the majority of the solids have been removed) and the bacterial food content, for example a combination of oxygen and/or nitrogen and/or phosphorous, of this influent is determined. In some preferred embodiments of such a food measuring procedure the fluid sample is diluted (with water), preferably to a high degree, prior to incubation, for example at least 90%, 95%, 98%, 99% or more dilution (that is leaving 10% or less of the original sample). This is because toxic materials in the influent can otherwise affect the bacterial growth process and dilution reduces the effective toxicity.

Experimental work has indicated that there is a relatively reliable, close to straight line correlation between the rate of pressure drop, for example pressure drop per hour and the influent food level. Thus embodiments of the method may comprise determining this rate of drop in pressure and then matching this to an influent food level, for example based upon a determined straight line (linear) relationship and/or a calibration curve. In preferred embodiments of the method the temperature is maintained at a substantially constant value, for example the temperature of the influent or a fixed or calibration temperature such as 20° C. Alternatively, however, a food level in a fluid from the plant may be determined dependent on one or more of a pressure drop, a rate of pressure drop, and an integrated pressure drop (area under a pressure-time curve).

In some embodiments of the method the level of food in the influent is determined by incubating the influent without RAS (returned activated sludge). In principle a measurement may be made on a fluid sample comprising a mixture of influent and RAS, although this is less preferable because RAS by itself metabolises and affects (reduces) the headspace gas pressure—the bacteria grow, die and feed off one another. Nonetheless, in embodiments it can be helpful to add biomass (bacteria) to an influent sample, in particular a very dilute influent sample. In this case, preferably a determined quantity (mass) of biomass is added. This may either be some level of biomass weight determined by a protocol of the method, or returned activated sludge, for example from the output of the plant, may be added to the dilute influent. In the former case the RAS may be dried, for example gently in a microwave, and a determined dry weight of biomass added. In the latter case the amount of biomass in the RAS may be measured (according to an embodiment of the invention) and then optionally an adjustment made to the change in pressure to account for any variations in the amount of biomass provided. In preferred embodiments an excess of the bacteria is provided, for example by adding substantially more bacteria than would in principle be needed to metabolise the food. This is advantageous because with a large quantity of bacteria, a relatively significant quantity of gas is consumed/produced even with a low level of food (dilute influent).

Embodiments of the method may additionally or alternatively be employed to determine a level of biomass in RAS from the plant, measuring the biomass content of the RAS fluid.

Either or both of the food and biomass measurements may be usefully employed in controlling a waste water treatment plant, in particular to control a degree of aeration of the plant. In this way embodiments of the method may be employed to reduce an overall energy consumption of the plant by controlling the level of aeration so that it is not substantially greater than that required by the quantity of food and/or biomass present.

In a related aspect the invention provides a system for measuring one or both of the food content and the biomass content of a fluid of a waste water treatment plant, the system comprising: a culture vessel comprising a sealable chamber for culturing a fluid sample and a pressure measurement transducer for measuring a pressure in a headspace of said sealable chamber; and a data processing system to: input pressure data from said pressure measurement transducer; and determine a value for one or both of said food content and said biomass content from a change in pressure measured by said pressure transducer.

In embodiments the data processing system may be implemented in hardware, in software, or using a combination of the two. Thus, for example, the data processing system may comprise a microprocessor coupled to working memory and to program memory storing processor control code for a procedure to implement the above described system/method. Optionally, in embodiments two culture vessels may be provided, one as a control.

### BRIEF DESCRIPTION OF THE DRAWINGS

These and other aspects of the invention will now be further described, by way of example only, with reference to the accompanying figures in which:

FIG. 1 shows a high level schematic diagram of a waste water treatment plant;

FIGS. 2a and 2b show a culture vessel for use in embodiments of the invention under, respectively normal atmospheric pressure and reduced pressure;

FIG. 3 shows the variation of pressure with time when incubating influent over a period of hours;

FIG. 4 shows a variation of pressure with time for different ratios of sample to headspace volume;

FIGS. 5a and 5b show, respectively, variation of pressure with time for different influent dilution levels, and pressure drop per hour against food level (larger food amounts towards the origin of the X-axis);

FIG. 6a to 6c show graphs of pressure against time for varying amounts of influent in combination with a constant amount of biomass (RAS) for, respectively, approximately 10 hours, approximately 100 minutes, and approximately 20 minutes; and

FIG. 7 shows a schematic block diagram of a control system for closed-loop control of a waste water treatment plant according to an embodiment of the invention.

### DETAILED DESCRIPTION OF PREFERRED EMBODIMENTS

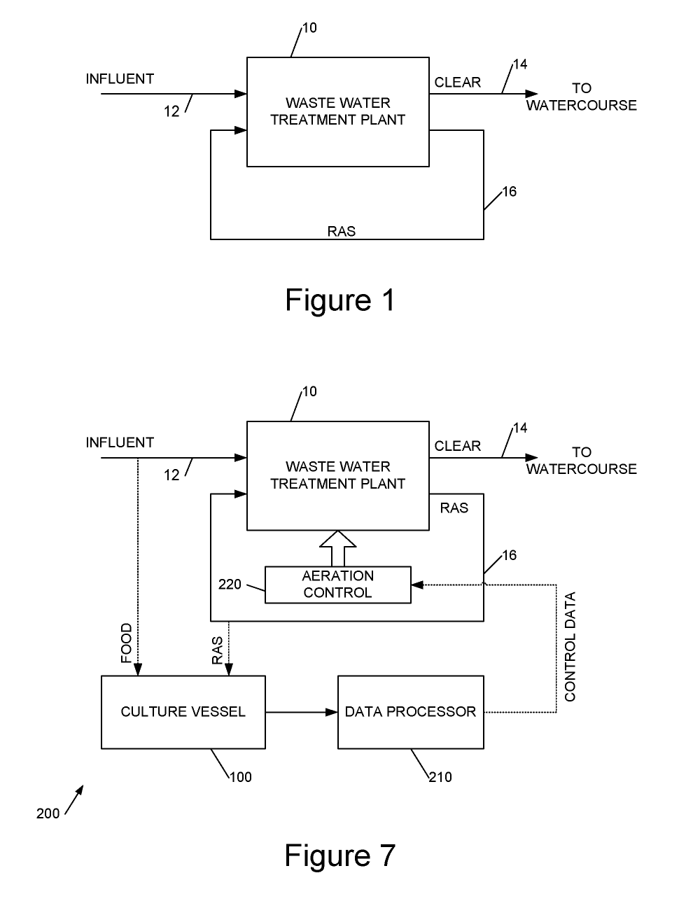

FIG. 1 shows, at a high level, a schematic diagram of the operation of a waste water treatment plant 10. Thus the plant accepts influent 12, fluid from which the solids have been substantially removed, containing a high level of ‘food’ for bacteria, protozoans and the like (‘biomass’) and having a high biochemical oxygen demand (BOD). The output from the plant has two components, a clear component 14 which may be provided to a water course and a biological component 16 comprising living biological material referred to as returned activated sludge (RAS), typically at around 60% concentration. The RAS is provided back to the input side of the plant to help maintain the eco system.

We have previously described a system for monitoring the metabolism/growth of microorganisms, the system comprising a sealed chamber with a flexible diaphragm to provide sensitive pressure measurements of gas pressure in the headspace above a culture liquid. For details reference may be made, for example, to US2005/0170497 (incorporated by reference).

The inventors have carried out significant experimental work on the suitability of such a system for application to fluids of a waste water treatment plant.

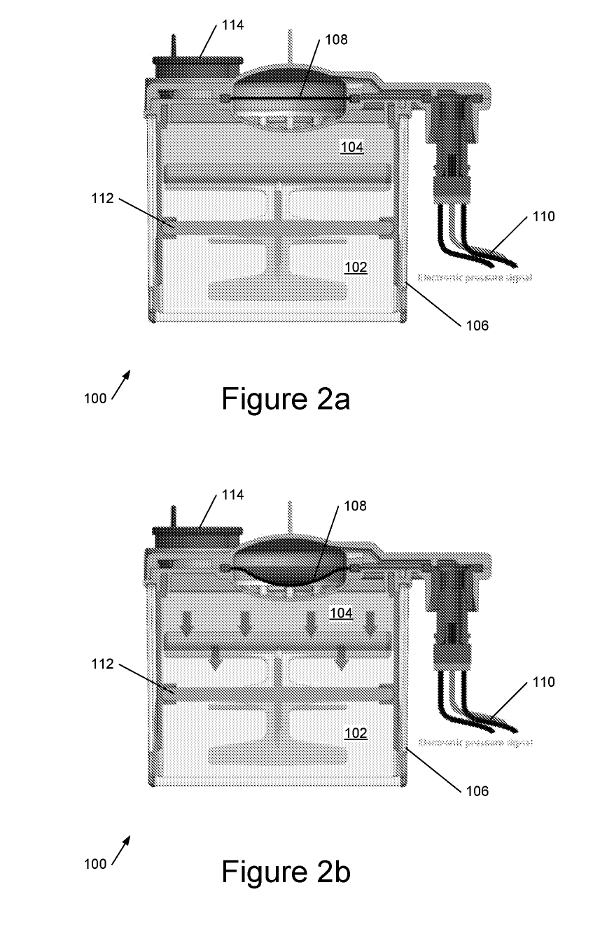

FIGS. 2a and 2b show, schematically, an embodiment of a similar device 100 under, respectively, normal atmospheric pressure and negative pressure (in operation either negative pressure or positive pressure may be produced). Thus a culture 102 of biological material undergoes metabolism and growth during which it exchanges gases with the aqueous liquid (water) carrying cells depending upon various factors gas may be used and/or produced, for example the cells may produce carbon dioxide during respiration. A gaseous headspace 104 of the sealed culture chamber 106 thus experiences changes in pressure due to exchange of gas with the culture medium, and these are monitored by a diaphragm 108 and converted to an electronic pressure signal 110 which may, for example, be digitised and processed electronically by hardware, software or a combination of the two. Preferably the system also includes an agitator 112 and temperature control (not shown), as well as a sealable inlet/outlet port 114.

Experiments were performed to determine what parameters can be measured by apparatus of the type illustrated in FIG. 2, in activated sludge and other waste water treatment plant fluids, in order to provide a system that reduces the need to aerate activated sludge thus reducing electricity cost in plant operation: Measuring and managing food to biomass ratio is an important factor in improving efficiency and lowering energy bills.

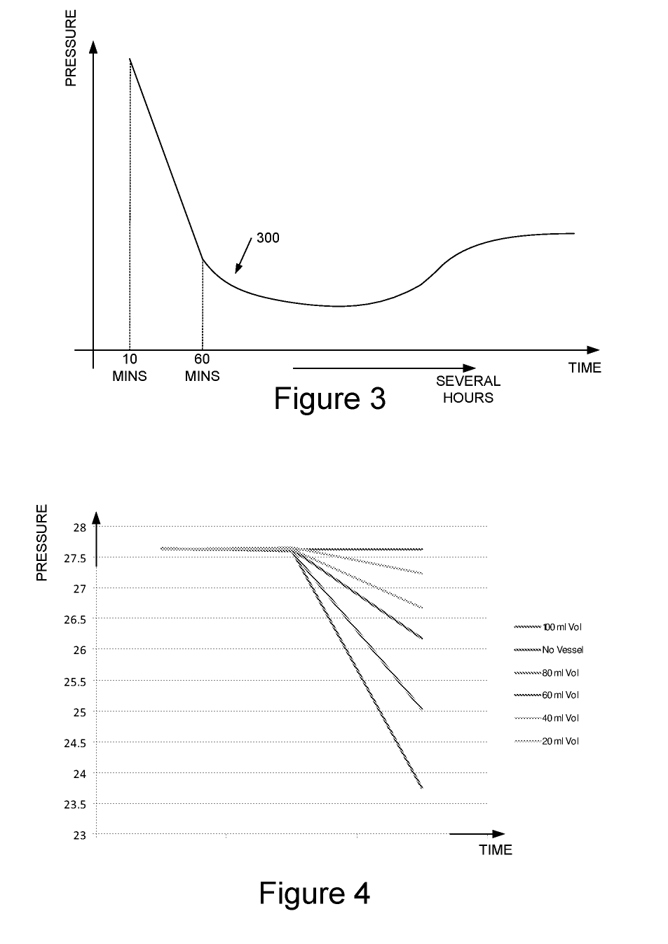

Initial experiments determined that the general shape of a pressure-time curve for influent to a plant is as illustrated in FIG. 3. Thus there is an initial period during which the pressure can vary and results appear unreliable. This typically lasts up to around 10 minutes. The pressure then begins to fall, flattening out in a trough region 300 after around an hour. Over a further period of several hours the pressure then gradually starts to rise once more (the graph of FIG. 3 is not to scale). The initial rate of pressure drop appears to be related to the concentration of food in the influent, a faster drop being observed with more food present. Here ‘food’ is used to describe material in all forms which facilitate the growth of bacteria (including, for example, more or less complex carbon sources, sources of oxygen, nitrogen, phosphorous, and ammonia, and also including, potentially, other bacteria). It is surmised that the pressure drop relates to the conversion of gas into living biomass since although oxygen is used during bacterial growth, carbon dioxide is produced. It is further surmised that the trough region occurs when the oxygen has been depleted, the subsequent smaller pressure rise relating to anaerobic respiration producing carbon dioxide. However the inventor does not wish to be bound by theory.

A graph broadly of the shape illustrated in FIG. 3 may be obtained from a sample of fluid from a plant comprising a mixture of influent and RAS, but in practice it can be helpful to separately monitor the influent input and RAS return paths to facilitate control of a plant based upon a food:biomass ratio.

Sample to Headspace Ratio

An experiment was performed to investigate the effect of the sample to headspace ratio in the sealed culture vessel. This showed that the liquid phase (sample) to gaseous phase (measured head space) volume ratio can be used to adjust the sensitivity of the test system.

One experimental protocol was as follows:
1. Fresh, settled (solids removed) influent was stored overnight at 4-8 Deg C. without aeration. A (normal) small amount of floating solids remained but very minor.
2. Fresh RAS (return activated sludge) was stored overnight at 4-8 Deg C. with aeration.
3. Influent was equilibrated to 20 deg C.
4. RAS was equilibrated to 20 deg C., washed 3 times in clean water and mixed 1:1 with Influent.
5. RAS/Influent mixture was added to culture vessels at varying volumes and mixed for 5 minutes open to the air.
6. Vessel sealed and logging started in bench rig.

FIG. 4 shows the variation of pressure with time with different sample volumes: Varying sample volume to headspace ratio gave significantly different pressure drop results, and the variation was reasonably consistent. A ratio of ˜1:1 was found to be useful for the particular development rig employed, with a working volume of ˜100 ml—but the skilled person will appreciate that this is particular to the rig employed. More importantly the experiments showed that the liquid phase to gaseous phase volume ratio is one easily modified parameter that can be adjusted to affect the rate of pressure change. This shows that test protocol may be modified to account for different test conditions and sensitivity requirements (within limits) if desired.

Some preferred applications of the techniques we describe measure food to biomass ratio. In one approach the amount of food entering the plant was measured by measuring just influent, without RAS. The hypothesis was that the pressure drop per hour would correlate with the amount of available food.

First Measurement of Food Entering the Plant (Influent)

This showed that the food concentration in the influent entering the activated sludge vessel can broadly speaking be measured by directly observing pressure change associated with metabolic rate of contaminating organisms plus the inherent chemical oxygen demand. A correlation with BOD (biochemical oxygen demand) seems reasonable.

One experimental protocol was as follows:
1. Fresh, settled (solids removed) influent was stored overnight at 4-8 Deg C. without aeration. A (normal) small amount of floating solids remained but very minor.
2. Influent was equilibrated to 20 deg C.
3. Dilutions of influent were made in water (temp equilibrated, not gassed) at 0%, 25%, 50%, 75%, and 100% for testing—to provide a controlled variation in food level
4. 30 ml added to culture vessels and mixed for 5 minutes open to the air.
5. 30 ml water added and left for 3 minutes.
6. Vessel sealed and logging started

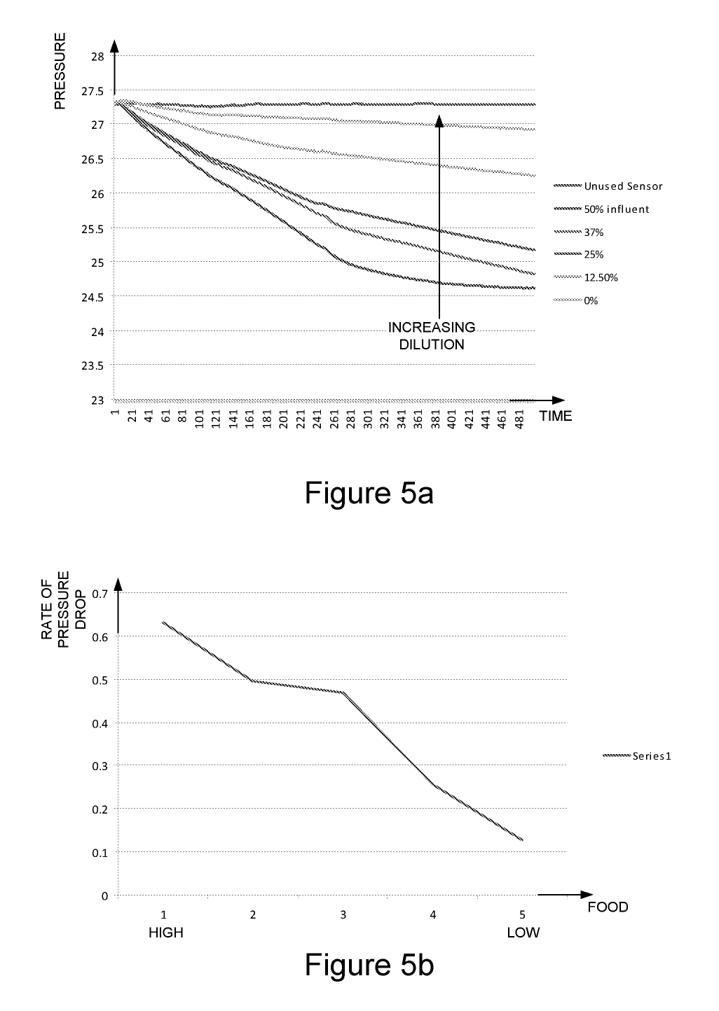

FIG. 5a shows the variation of pressure with time with varying degrees of dilution, in effect, the amount of food present. FIG. 5b shows that there is an approximate straight line correlation between the rate of pressure drop (pressure drop per hour) and the available food—in this case the amount of influent, but this could equally be the amount of food in an influent sample. (In FIG. 5b the left hand side of the x-axis corresponds to a high level of food/influent, and vice-versa).

From FIG. 5 it can be seen that there is a variable pressure drop dependent upon the concentration of influent; that the pressure drop can be correlated to influent concentration in a straight line relationship (allowing for experimental error); and that the measurement works within a target time course of 60 minutes.

This demonstrates that apparatus of the type illustrated in FIG. 2 can be used for direct measurement of influent concentration using a measurement of headspace volume pressure. This correlation of FIG. 5 indicates that this technology can be employed to test for the level of food entering the activated sludge process. In practice the measurement may be a measurement of both BOC and COD (chemical oxygen demand)—but if so this is potentially advantageous for aeration control. Preferably the sample is aerated (pre-gassed) prior to measurement, to avoid variations due to different levels of initial oxygen concentration in the influent.

In an alternative approach, rather than measure just the influent, the influent is measured in combination with biomass, in particular RAS. This provides a more particular determination of the bacteria's reaction to the particular food source, and in embodiments the RAS may be derived from the plant being monitored/controlled. Because the RAS itself is active in the sense that it gives rise to a pressure drop, either a constant biomass may be employed or the amount of biomass added may be measured. A measurement of the biomass may either be made by heating a sample, for example by microwaving the sample, to determine the dry weight of biomass or by measuring the amount of biomass indirectly by culturing the biomass as described later. In embodiments incubating the food source in combination with biomass serves to amplify the signal generated by the food since even with a small amount of food, having a large, more particularly excess quantity of biomass will generate/use a more readily measureable quantity of gas, and hence can provide more rapid results. (Here ‘excess’ bacteria is a quantity of bacteria large enough that the rate of metabolism of the food is not limited by the quantity of biomass).

Thus further experiments were performed to investigate the incubation of influent in combination with biomass.

Second Measurement of Food Entering the Plant (Influent)

The measurement of food entering the plant using RAS Biomass activity aimed to measure food concentration as a function of Biological Oxygen Demand. In embodiments this approach provides a BOD5 test proxy. The experiments showed that using high biomass concentration and low food concentration, one can mimic the long BOD5 test in a shorter time, for example of order 1 hour. In embodiments the technique measures rate of metabolism as a function of the amount of food available. Thus the technique is able to provide a device, in embodiments operating under software control, to rapidly measure the Biological Oxygen Demand of water samples using the pressure change and/or rate of pressure change and/or integrated pressure change, in test sample.

One experimental protocol was as follows:
1. Fresh, settled (solids removed) influent was stored overnight at 4-8 Deg C. without aeration. Note: a (normal) small amount of floating solids remained but very minor.
2. Influent was equilibrated to 20 deg C.
3. RAS was equilibrated to 20 deg C., unmixed but in large surface area vessel, shaken every 15 minutes.
4. Dilutions of influent were made in water (temp equilibrated, not gassed). 0%, 2.5%, 5.0%, 7.5%, & 10% for testing
5. 30 ml RAS added to culture vessels and mixed for 15 minutes open to the air.
6. 30 ml Diluted Influent sample added to culture vessels and mixed for 3 minutes open to the air.
7. Vessel sealed and logging started

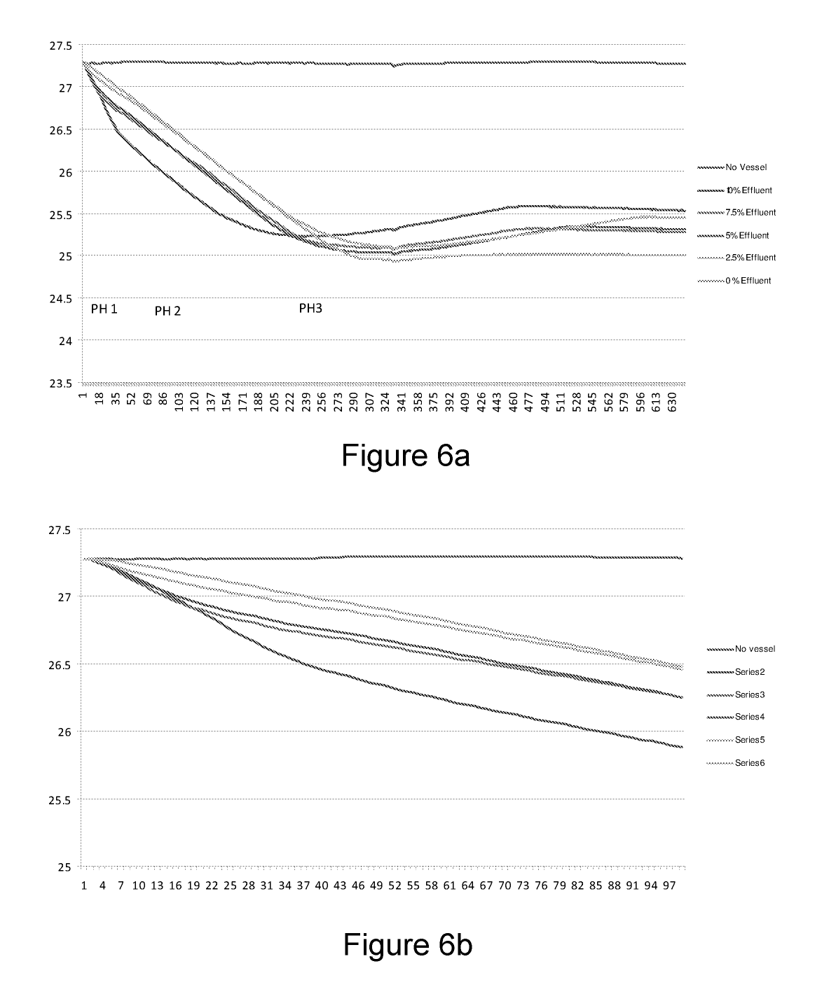

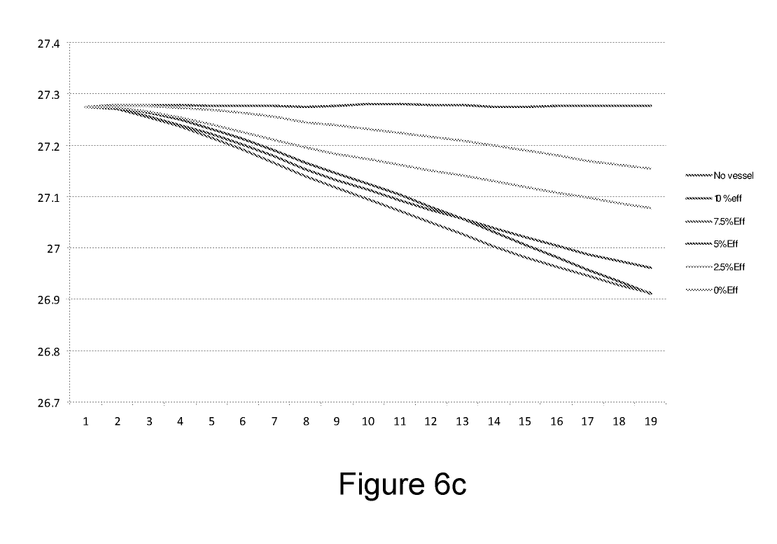

FIG. 6a shows the variation of pressure with time with varying degrees of dilution, in effect, varying the amount of food present, over a period of around 10 hours. FIG. 6b shows, on an expended scale, the first 100 minutes (Phase 1—Ph1—in FIG. 6a), and FIG. 6c the first 20 minutes (Phase 2—Ph2—in FIG. 6a).

It can be seen that there is a three stage pressure curve for each dilution, with a clear difference in pressure drop between samples in phase 1. The phase 1 pressure drop correlates to sample concentration, i.e. the amount of food present. This demonstrates that this approach provides a feasible substitute for a BOD5 test, but on a timescale shortened by around two orders of magnitude.

The transition time of Phase 1 to Phase 2, which corresponds to a change in slope, varies between samples and the time of the transition correlates with the amount of food (the larger the amount of food, the sharper the initial pressure drop and the earlier the transition to the gentler slope of phase 2). However the Phase 1-2 timing and rate changes may also be dependent on the level of oxygenation (the sample is almost anaerobic), and thus preferably the sample is oxygenated prior to incubation/measurement. The phase 2 pressure drop rate is consistent between samples.

The time of the transition from phase 2 to phase 3 also varies between samples, also apparently correlates with the rapidity of initial oxygen depletion (higher food content samples show more rapid oxygen depletion), although it is harder to see from the curves. The time to the point at which the pressure drop reaches zero (which may relate to the time to depletion of the available oxygen) apparently correlates with the amount of oxygen used by a given biomass, dependent upon the food availability. The results also apparently correlate with those from a BOD5 test. Similarly the area under the pressure-time curve to this point may also be used as an indication of the amount of food available and, in embodiments, as a proxy for a BOD5 test.

Thus a closed vessel pressure measurement, as previously described, can used as a measure of oxygen utilisation by a given body of biomass with time, consistent with the food availability.

Some experiments on fluid samples from sewage treatment works showed strange results that might indicate background toxicity in some influent samples—for example slightly diluted samples could sometimes appear to have higher metabolic rate than neat samples. Discussions with plant staff elucidated that background toxic events can be very common as sites often accept tankers of high concentration effluent. Thus dilution of samples can be useful to remove background toxic or inhibitory components/effects which can otherwise interfere with obtaining accurate results.

Choosing a suitable level of dilution was found to be important in practice to see differences between fluid samples, sometimes to see any differences. Thus an initial step of characterising a plant to determine a correct dilution range to employ can be important, and in general the degree of dilution will vary from plant to plant.

Similarly a pre-oxygenation step is also helpful to reduce the risk of a test being unduly influenced by an inherent oxygen level in a sample. More generally, a step equilibrate gaseous composition of biologically active samples or to control the level of gas, in particular oxygen, in a sample is helpful. Temperature control is also useful, in part because of the varying gas-dissolving ability of water at different temperatures.

In a further set of experiments samples of RAS were diluted and then incubated using protocols along broadly the same lines as those described above. The bacteria in RAS metabolise on their own and thus, in a similar way to the approach used for influent, it has been experimentally determined that the pressure drop correlates with the biomass in RAS return. Thus this can be used as a measure of the biomass present in RAS return of a water treatment plant. This can then be used in combination with a measure of food in the plant, for example from influent as described above, to determine a ratio of values which approximate the food to biomass ratio in the plant. The plant aeration may then be controlled dependent on this, increasing the aeration when there is a large quantity of food for the available biomass, and vice versa.

FIG. 6 shows a block diagram of a closed loop based water treatment control system 200 to implement real time closed loop control of RAS water treatment based upon measurement or pressure changes in a closed vessel/sealed chamber. Thus one or both of food and RAS samples are provided to a culture vessel, for example of the type shown in FIG. 2, and the overall changes in gas pressure (a combination of oxygen used an CO² produced, among other potential influencing factors) is monitored by a data processor 210, for example a general purpose computer under software control. The data processor output data, for example as a parameter such as a number indicating the amount of food and/or RAS in the plant and/or some combination of these such as food to biomass ratio. This data may either be output on a screen for an operator to employ in controlling the plant or the data processor 210 may interface directly or indirectly with an aeration control system 220 for the plant to control the aeration such that it is sufficient, but not significantly in excess of that required given the amount of food/biomass the plant is coping with. This in turn enables the plant to operate efficiently but also to react to shock loads and variations in food/biomass levels over time periods of one or more days, weeks, months or years.

No doubt many other effective alternatives will occur to the skilled person. It will be understood that the invention is not limited to the described embodiments and encompasses modifications apparent to those skilled in the art lying within the spirit and scope of the claims appended hereto.

1. A method of closed-loop control of a waste water treatment plant, the method comprising:
obtaining a fluid sample from a fluid of said plant;
providing said fluid sample to a sealed chamber such that said fluid sample incompletely fills said sealed chamber leaving a headspace;
incubating said fluid sample in said sealed chamber;
determining a change in pressure in said headspace during said incubating; and
controlling a degree of aeration of said waste water treatment plant responsive to said change in pressure.

2. A method as claimed in claim 1 wherein said fluid sample comprises a sample of influent to said plant.

3. A method as claimed in claim 1 wherein said fluid sample comprises a sample of returned activated sludge (RAS) in said plant.

4. A method as claimed in claim 1, comprising:
obtaining a first said fluid sample comprising a sample of influent to said plant;
obtaining a second said fluid sample comprising a sample of returned activated sludge (RAS) in said plant;
determining respective first and second changes in headspace pressure during incubating of said first and second fluid samples respectively;
determining respective first and second parameters from said first and second changes in headspace pressure; and
controlling said degree of aeration responsive to a combination of said first and second parameters.

5. A method as claimed in claim 4 wherein said combination of parameters defines a ratio of food to biomass for said plant.

6. (canceled)

7. A method as claimed in claim 1 further comprising diluting said fluid sample by at least 90% prior to said incubating.

8. A method as claimed in claim 1 further comprising aerating said fluid sample prior to said incubating.

9. A method as claimed in claim 1 wherein said determining of said change in pressure comprises disregarding changes in pressure during an initial period of said incubating.

10. A method as claimed in claim 1 wherein said determining of said change in pressure comprises determining a rate of change of said pressure to determine a food level parameter relating to a level of food in or supplied to said plant, and controlling said degree of aeration responsive to said food level parameter.

11. A method as claimed in claim 1 comprising adjusting a volume of said headspace to adjust a sensitivity of said closed loop control.

12. A method as claimed in claim 1 further comprising diluting said fluid sample prior to said incubating, and adjusting a degree of said dilution to adjust a sensitivity of said closed loop control.

13. A control system for closed-loop control of a waste water treatment plant, the system comprising:
a culture vessel comprising a sealable chamber for culturing a fluid sample and a pressure measurement transducer for measuring a pressure in a headspace of said sealable chamber; and
a data processing system to:
input pressure data from said pressure measurement transducer;
determine at least one parameter relating to said plant from said pressure data; and
output data, for controlling a degree of aeration of said plant, dependent on said at least one parameter.

14. A control system as claimed in claim 13 wherein said data processing system is further configured to:
determine a degree of aeration for said plant from said at least one parameter; and
output aeration control data, for controlling a degree of aeration of said plant, dependent on a said determined degree of aeration.

15. (canceled)

16. A method of measuring one or both of the food content and the biomass content of a fluid of a waste water treatment plant, the method comprising:
obtaining a fluid sample from a fluid of said plant;
providing said fluid sample to a sealed chamber such that said fluid sample incompletely fills said sealed chamber leaving a headspace;
incubating said fluid sample in said sealed chamber;
determining a change in pressure in said headspace during said incubating; and
determining a value for one or both of said food content and said biomass content from said change in pressure.

17. A method as claimed in claim 16 wherein said change in pressure comprises a fall in pressure, wherein said fluid sample comprises a sample of influent to said plant, and wherein said measuring comprises determining a value for said food content of said influent.

18-22. (canceled)

23. A method as claimed in claim 16 wherein said fluid sample comprises a sample of influent to said plant, and said determining of said value for said food content of said influent comprises determining a rate of drop in said pressure.

24. (canceled)

25. A method as claimed in claim 16 further comprising adding bacteria to said fluid sample comprising adding one or both of a determined biomass of said bacteria and an excess of said bacteria.

26. A method as claimed in claim 25 wherein said bacteria comprise RAS (returned activated sludge) from said plant.

27. A method as claimed in claim 26 wherein said fluid sample comprises a sample of influent to said plant and the method further comprising obtaining an RAS fluid from said plant and determining a level of RAS in said RAS fluid; and wherein said determining of said value for said food content of said influent includes compensating for a said pressure change dependent on said level of RAS.

28. A method as claimed in claim 16 wherein said fluid sample comprises a sample by returned activated sludge (RAS) fluid in said plant, and wherein said measuring comprises determining a value for said biomass content of said RAS fluid.

29-31. (canceled)
